(19) United States
(12) Patent Application Publication
(10) Pub. No.: US 2023/0068448 A1
(43) Pub. Date: Mar. 2, 2023

(54) CHEMICAL SENSOR APPARATUS

(71) Applicant: KABUSHIKI KAISHA TOSHIBA, Tokyo (JP)

(72) Inventor: Yoshiaki SUGIZAKI, Fujisawa Kanagawa (JP)

(73) Assignee: KABUSHIKI KAISHA TOSHIBA, Tokyo (JP)

(21) Appl. No.: 17/672,007

(22) Filed: Feb. 15, 2022

(30) Foreign Application Priority Data
Sep. 2, 2021 (JP) 2021-143222

(51) Int. Cl. G01N 27/414

(52) U.S. Cl. CPC G01N 27/414

(57) ABSTRACT

A chemical sensor apparatus includes a buffer solution including not less than 0.5 mM and not more than 6 mM of chlorine ions; a sensor element including a surface immersed in the buffer solution; and a silver/silver chloride electrode immersed in the buffer solution. The silver/silver chloride electrode applies a potential to the buffer solution, and includes silver chloride at a surface of the silver/silver chloride electrode.

### CROSS-REFERENCE TO RELATED APPLICATION

This application is based upon and claims the benefit of priority from Japanese Patent Application No. 2021-143222, filed on Sep. 2, 2021; the entire contents of which are incorporated herein by reference.

### FIELD

Embodiments described herein relate generally to a chemical sensor apparatus.

### BACKGROUND

There is a chemical sensor that detects a specimen in a solution by using a graphene FET (Field Effect Transistor).

### BRIEF DESCRIPTION OF THE DRAWINGS

FIG. 1 is a schematic configuration diagram showing an example of a module that uses a chemical sensor apparatus of an embodiment;

FIG. 2 is a schematic view showing an example of a molecule intake unit shown in FIG. 1;

FIG. 3 is a schematic view showing another example of the molecule intake unit shown in FIG. 1;

FIG. 4 is a schematic view of a channel chip of the molecule intake unit shown in FIG. 3;

FIG. 5 is a schematic configuration diagram showing another example of the module that uses the chemical sensor apparatus of the embodiment;

FIG. 6 is a schematic configuration diagram showing another example of the module that uses the chemical sensor apparatus of the embodiment;

FIG. 7 is a schematic view showing an example of a sensor chip of the embodiment;

FIGS. 8A and 8B are schematic views showing an example of a sensor cartridge of the embodiment;

FIGS. 9A and 9B are schematic views showing an example of the chemical sensor apparatus of the embodiment;

FIGS. 10A and 10B are schematic views showing another example of the chemical sensor apparatus of the embodiment;

FIG. 11 is a schematic view of a sensor chip used in experiments; and

FIGS. 12 to 21 are graphs illustrating experiment results using the sensor chip of FIG. 11.

### DETAILED DESCRIPTION

According to one embodiment, a chemical sensor apparatus includes a buffer solution including not less than 0.5 mM and not more than 6 mM of chlorine ions; a sensor element including a surface immersed in the buffer solution; and a silver/silver chloride electrode immersed in the buffer solution. The silver/silver chloride electrode applies a potential to the buffer solution, and includes silver chloride at a surface of the silver/silver chloride electrode.

Embodiments will now be described with reference to the drawings. The same components in the drawings are marked with the same reference numerals.

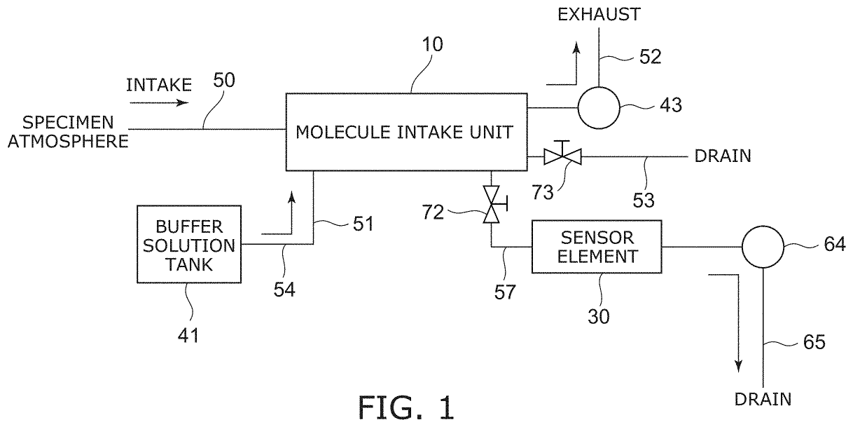

FIG. 1 is a schematic configuration diagram showing an example of a module that uses a chemical sensor apparatus of an embodiment.

A molecule intake unit 10 is connected to an intake pipe 50 and an exhaust pipe 52. An intake/exhaust device 43 is connected to the exhaust pipe 52. The intake/exhaust device 43 is, for example, a pump or a fan. A specimen atmosphere is pulled into the molecule intake unit 10 via the intake pipe 50 by the driving of the intake/exhaust device 43. The detection object of the chemical sensor apparatus shown in FIG. 1 is a molecule (a target molecule) included in the specimen atmosphere.

The molecule intake unit 10 is connected to a supply source of a buffer solution. For example, the molecule intake unit 10 is connected via a pipe 54 to a buffer solution tank 41 in which the buffer solution is stored. The buffer solution includes, for example, a phosphoric acid buffer solution or HEPES (hydroxyethylpiperazine ethanesulfonic acid) buffer solution. The buffer solution also includes not less than 0.5 mM and not more than 6 mM of chlorine ions.

The buffer solution is supplied from the buffer solution tank 41 to the molecule intake unit 10. A specimen atmosphere that has a possibility of including the target molecule is exposed to the buffer solution by the molecule intake unit 10.

The molecule intake unit 10 is connected to a sensor element 30 via a pipe 57. As necessary, a valve 72 is connected to the pipe 57. Also, as necessary, the molecule intake unit 10 is connected to a pipe 53 for drainage; and a valve 73 is connected to the pipe 53.

The sensor element 30 is connected to a pipe 65 for drainage; and a valve 64 is connected to the pipe 65.

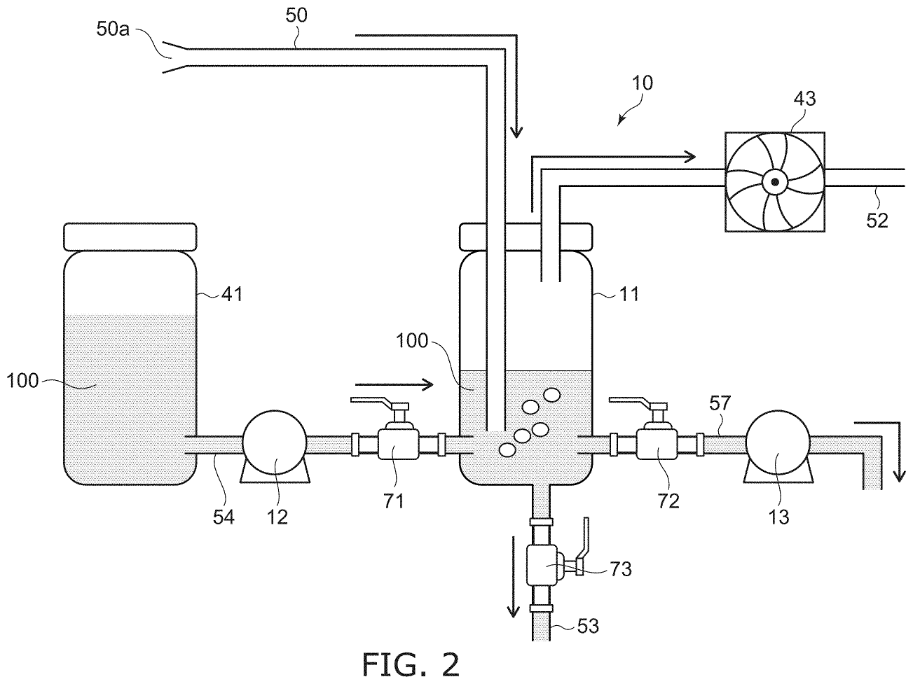

FIG. 2 is a schematic view showing an example of the molecule intake unit 10.

The molecule intake unit 10 includes a mixing tank 11 in which bubbling of the specimen atmosphere in the buffer solution is performed. The mixing tank 11 is connected to the buffer solution tank 41 via the pipe 54. A pump 12 and a valve 71 are connected to the pipe 54. By opening the valve 71 and driving the pump 12, a buffer solution 100 that is stored in the buffer solution tank 41 is supplied to the mixing tank 11.

An atmosphere collection port 50a that is positioned outside the mixing tank 11 is formed at one end portion of the intake pipe 50. The other end portion of the intake pipe 50 is positioned in the buffer solution 100 inside the mixing tank 11. One end portion of the exhaust pipe 52 is positioned in a vapor phase portion above the buffer solution 100 inside the mixing tank 11; and the other end portion of the exhaust pipe 52 is used as an exhaust port. The intake/exhaust device 43 is connected partway through the exhaust pipe 52 between the mixing tank 11 and the exhaust port. By driving the intake/exhaust device 43, the specimen atmosphere is pulled into the intake pipe 50 from the atmosphere collection port 50a and caused to bubble through the buffer solution inside the mixing tank 11; and the target molecule in the specimen atmosphere is dissolved in the buffer solution.

The mixing tank 11 is connected to the sensor element 30 via the pipe 57. The valve 72 and a pump 13 are connected to the pipe 57, By opening the valve 72 and driving the pump 13, the buffer solution 100 inside the mixing tank 11 is supplied to the sensor element 30.

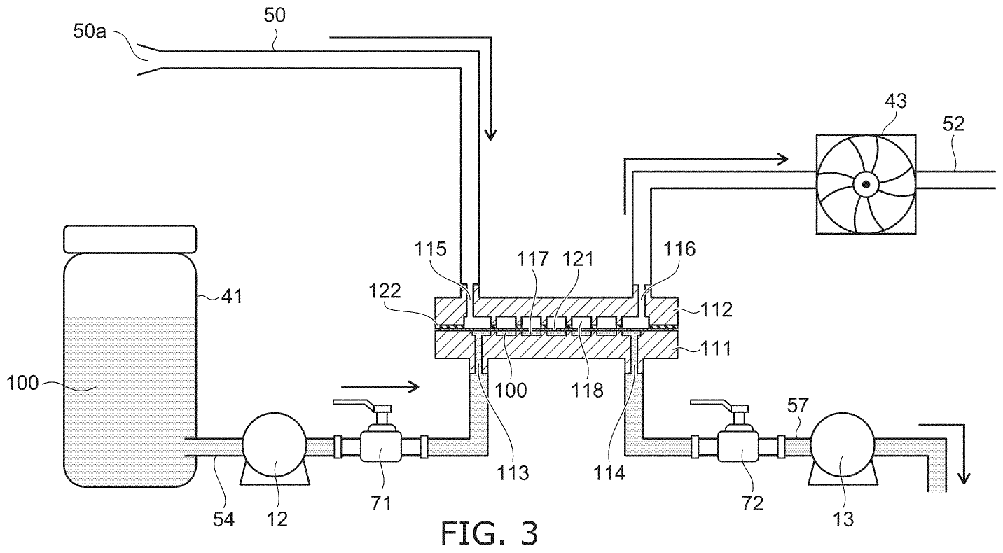

FIG. 3 is a schematic view showing another example of the molecule intake unit 10 shown in FIG. 1.

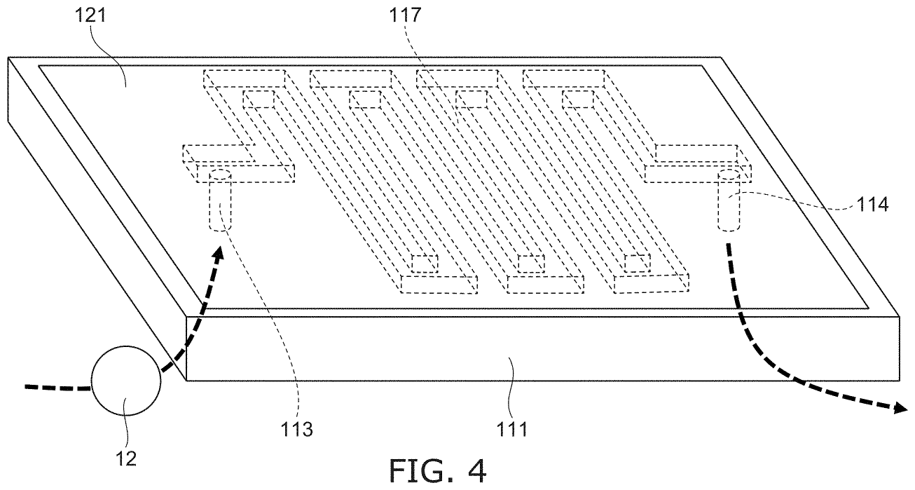

FIG. 4 is a schematic view of a channel chip 111 shown in FIG. 3.

The molecule intake unit includes the channel chip 111, a lid 112 overlaid on the channel chip 111, and a porous membrane 121 located between the channel chip 111 and the lid 112.

As shown in FIG. 4, a liquid inflow channel 113 that is connected to one end portion of a channel 117 and a liquid outflow channel 114 that is connected to the other end portion of the channel 117 are formed in the channel chip 111. As shown in FIG. 3, the liquid inflow channel 113 is connected to the pipe 54 to which the buffer solution 100 is supplied; and the liquid outflow channel 114 is connected to the pipe 57 that is connected to the sensor element 30.

As necessary, an unevenness can be formed in the bottom surface of the channel 117. For example, an asymmetric V-shaped groove called a chaotic mixer can be formed as the unevenness, By forming such an unevenness, stirring occurs inside the micro flow channel that easily tends to have laminar flow; and the intake efficiency of the target molecule via the porous membrane 121 described below is increased.

The porous membrane 121 covers the channel 117. The lid 112 is located on the porous membrane 121. The lid 112 is closely adhered to the porous membrane 121 via a sealing member (e.g., a rubber member) 122. A channel 118 that has the same pattern as the channel 117 with mirror symmetry is formed in the surface of the lid 112 facing the porous membrane 121.

An intake path 115 that is connected to one end portion of the channel 118 and an exhaust path 116 that is connected to the other end portion of the channel 118 are formed in the lid 112. The intake path 115 is connected to the intake pipe 50 that intakes the specimen atmosphere; and the exhaust path 116 is connected to the exhaust pipe 52.

By opening the valves 71 and 72 and driving the pumps 12 and 13, the buffer solution 100 that is stored in the buffer solution tank 41 is supplied from the liquid inflow channel 113 to the channel 117. The buffer solution 100 does not pass through the porous membrane 121. Accordingly, the buffer solution 100 does not flow into the channel 118 above the porous membrane 121. Only one of the pump 12 or the pump 13 may be used.

By driving the intake/exhaust device 43 connected to the exhaust pipe 52, the specimen atmosphere that is pulled into the intake pipe 50 from the atmosphere collection port 50a flows into the channel 118 from the intake path 115. The target molecule in the specimen atmosphere passes through the porous membrane 121, enters the channel 117 to which the buffer solution is supplied, and dissolves in the buffer solution that flows through the channel 117.

The buffer solution inside the channel 117 that is exposed to the specimen atmosphere flows as-is through the liquid outflow channel 114 and is supplied to the sensor element 30.

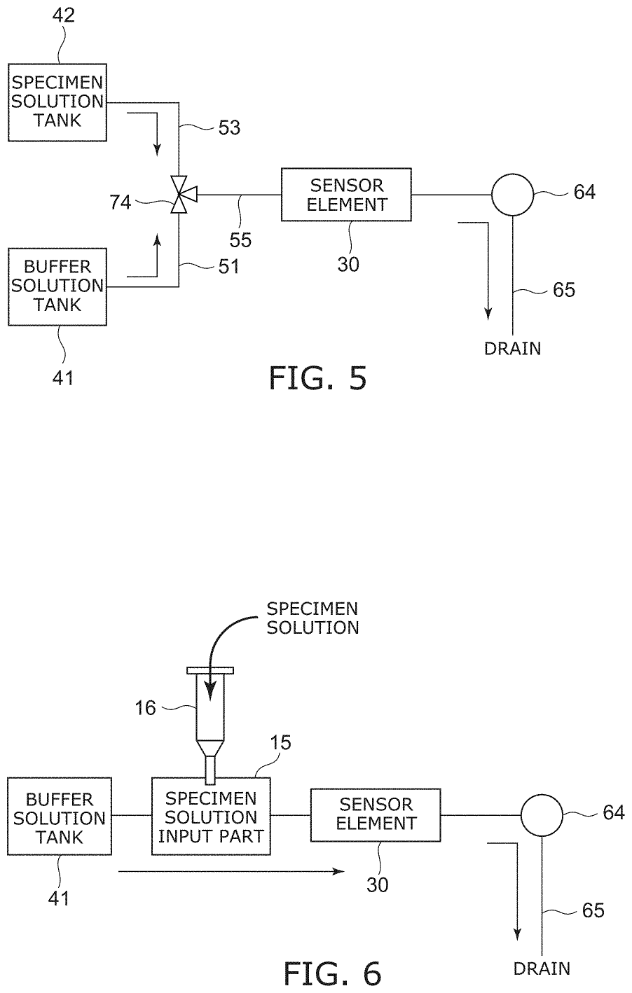

FIG. 5 is a schematic configuration diagram showing another example of the module that uses the chemical sensor apparatus of the embodiment.

In the example shown in FIG. 5, the detection object of the chemical sensor apparatus is a molecule (a target molecule) included in a liquid. A specimen solution tank 42 in which a specimen solution that has a possibility of including the target molecule is stored and the buffer solution tank 41 in which the buffer solution is stored are connected to the sensor element 30 via a three-way valve 74. The specimen solution tank 42 is connected to the three-way valve 74 via the pipe 53. The buffer solution tank 41 is connected to the three-way valve 74 via a pipe 51. The sensor element 30 is connected to the three-way valve 74 via a pipe 55. By this configuration, the surface of the sensor element 30 can be immersed in the solutions of the specimen solution and the buffer solution or a mixed liquid of the specimen solution and the buffer solution.

As shown in FIG. 6, a configuration may be used in which a specimen solution input part 15 is connected between the buffer solution tank 41 and the sensor element 30. The buffer solution is supplied from the buffer solution tank 41 to the specimen solution input part 15. Also, an input device 16 is connected to the specimen solution input part 15. A specimen solution from the input device 16 is input to the buffer solution supplied to the specimen solution input part 15. The buffer solution in which the specimen solution is mixed is supplied from the specimen solution input part 15 to the sensor element 30.

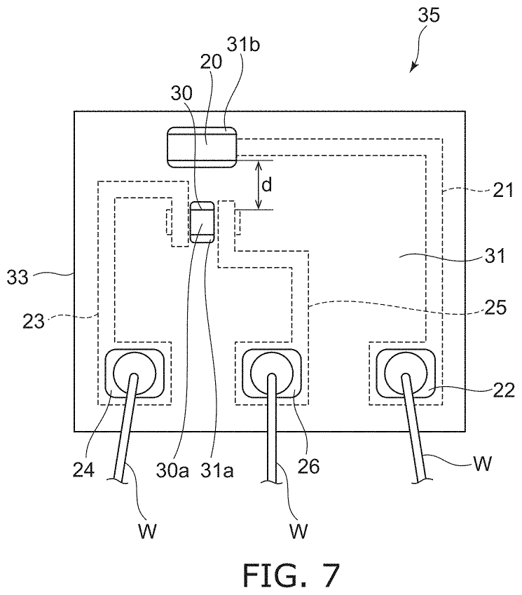

For example, the sensor element 30 is located on a substrate 33 of a sensor chip 35 shown in FIG. 7. The sensor element 30 is, for example, a FET (Field Effect Transistor) element that includes graphene. A graphene film is located on the substrate 33.

Also, a first electrode 23, a second electrode 25, and a silver/silver chloride electrode 20 are located on the substrate 33. One of the first electrode 23 or the second electrode 25 functions as a drain electrode of the FET; and the other of the first electrode 23 or the second electrode 25 functions as a source electrode of the FET. The silver/silver chloride electrode 20 functions as a gate electrode of the FET. A current (a drain current) can flow via the graphene film between the first electrode 23 and the second electrode 25.

One end portion of the first electrode 23 and one end portion of the second electrode 25 contact the graphene film. A pad 24 is located at the other end portion of the first electrode 23. A pad 26 is located at the other end portion of the second electrode 25. The silver/silver chloride electrode 20 is connected to a pad 22 via a gate interconnect 21.

An insulating film 31 that covers the aforementioned components on the substrate 33 is located on the substrate 33. An opening 31a that exposes a surface 30a of the sensor element 30 (the surface of the graphene film) is formed in the insulating film 31. Also, an opening 31b that exposes the silver/silver chloride electrode 20 is formed in the insulating film 31. The pad 24, the pad 26, and the pad 22 are not covered with the insulating film 31. Gold wires W are bonded respectively to the exposed portions of the pads 24, 26, and 22.

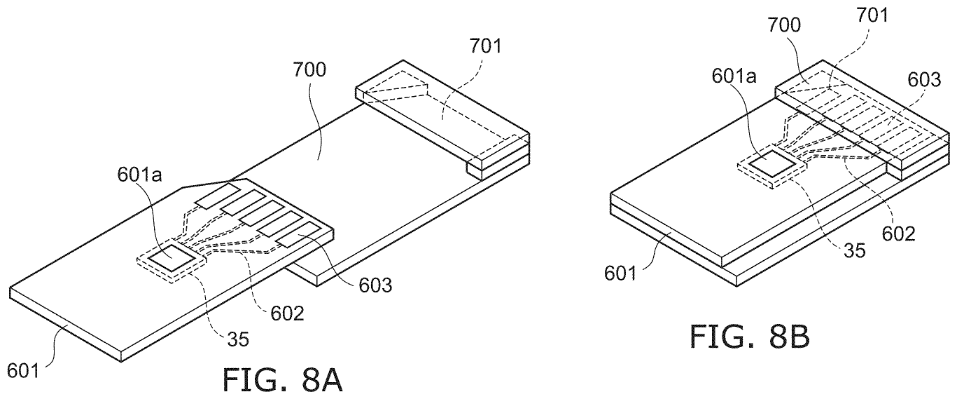

For example, the sensor chip 35 shown in FIG. 7 is mounted to a sensor cartridge 601 shown in FIGS. 8A and 8B. An opening 601a that exposes the silver/silver chloride electrode 20 and the surface of the sensor element 30 is provided in the sensor cartridge 601. Also, internal wiring 602 that is electrically connected to the first electrode 23, the second electrode 25, and the silver/silver chloride electrode 20 of the sensor chip 35 and terminals 603 that are electrically connected to the internal wiring 602 are located in the sensor cartridge 601.

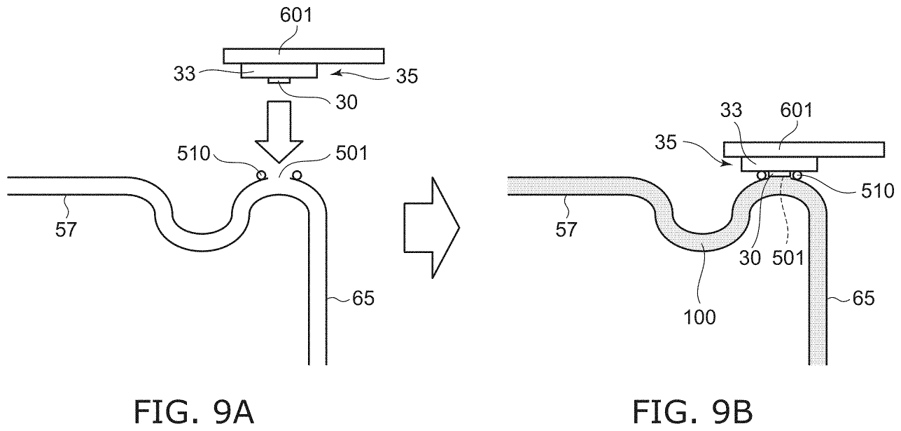

As shown in FIG. 9B, the terminals 603 of the sensor cartridge 601 are inserted into a socket part 701 of a socket substrate 700.

FIGS. 9A and 9B show an example of mounting the sensor element 30 to, for example, the pipes 57 and 65 shown in FIG. 1.

An opening 501 is made in the pipes 57 and 65; and a packing 510 is formed at the outer perimeter of the opening 501. For example, the sensor element 30 is mounted to the sensor cartridge 601 in the state of the sensor chip 35 described above.

As shown in FIG. 9B, by mounting the surface of the sensor element 30 to face a portion of the opening 501, the surface of the sensor element 30 is made airtight by the packing 510 and is exposed inside the pipes 57 and 65. The sensor cartridge 601 and/or the substrate 33 to which the sensor element 30 is mounted are attachable to and detachable from the opening 501. By such a configuration, the sensor element 30 can be attached and detached as a replacement part and/or a consumable part in a sensor mounting part in which the opening 501 is formed in the pipes 57 and 65.

The surface 30a of the sensor element 30 (the surface of the graphene film) that is exposed inside the pipes 57 and 65 is immersed in the buffer solution 100 inside the pipes 57 and 65 and can detect the target molecule in the buffer solution by using the change of the drain current of the sensor element 30, etc.

The silver/silver chloride electrode 20 that is provided on the substrate 33 together with the sensor element 30 also is exposed inside the pipes 57 and 65 through the opening 501. The silver/silver chloride electrode 20 is immersed in the buffer solution 100 inside the pipes 57 and 65 and applies a potential to the buffer solution 100. The silver/silver chloride electrode 20 is not limited to being provided on the substrate 33 together with the sensor element 30.

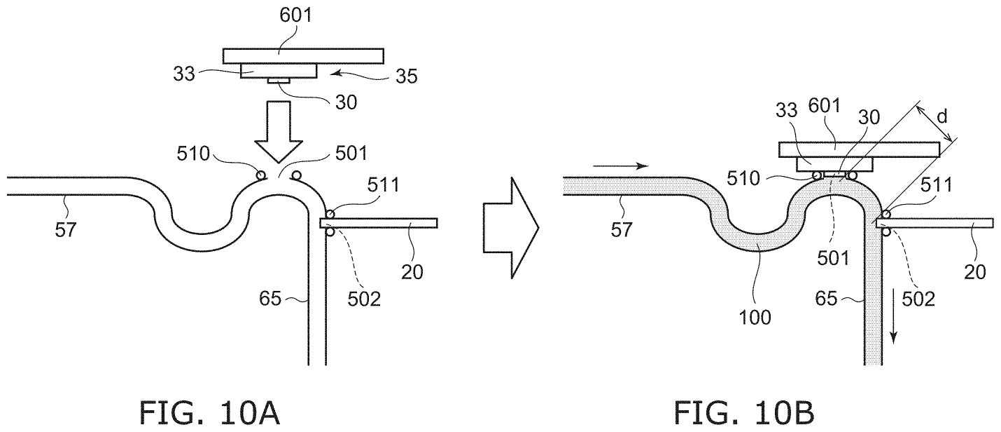

For example, as shown in FIGS. 10A and 10B, the silver/silver chloride electrode 20 also can be exposed inside the pipes 57 and 65 and immersed in the buffer solution 100 through a second opening 502 that is separate from the opening (a first opening) 501 that exposes the surface of the sensor element 30 inside the pipes 57 and 65. Or, the silver/silver chloride electrode 20 may be directly built into the interior of the pipes 57 and 65.

The silver/silver chloride electrode 20 that includes silver chloride at the surface is immersed in the buffer solution including the chlorine ions and applies a potential to the buffer solution due to an oxidation-reduction reaction that occurs. The potential of the buffer solution is controlled to have a constant potential difference with respect to the potential of the silver/silver chloride electrode 20 according to the Nernst equation. The chlorine ions (Cl⁻) in the buffer solution move between the buffer solution and the silver/silver chloride electrode 20 surface until the potential of the buffer solution stabilizes due to the oxidation-reduction reaction (AgCl+e⁻→Ag+Cl⁻) with silver chloride (AgCl). The Nernst equation of the silver/silver chloride electrode is represented by the following formula,

E=E(RT/F)In aAg⁺≈E⁰−(RT/F)In aCl⁻

E is the electrode potential; E⁰ is the standard electrode potential; R is the gas constant; T is the temperature; F is the Faraday constant; aAg⁺ is the activity of the silver ions; and aCl⁻ is the activity of the chlorine ions. According to the Nernst equation, the potential difference between the silver electrode and the buffer solution is determined by the activity of Cl⁻.

There is a reference electrode that uses this principle to control the potential difference between the silver/silver chloride electrode and the buffer solution to be constant. Normally, for the reference electrode, a high salt concentration solution such as a potassium chloride saturated aqueous solution or the like is used to stabilize the potential difference between the silver/silver chloride electrode and the buffer solution.

Potential difference control that uses the reference electrode configuration of the silver/silver chloride electrode cannot be applied to a chemical sensor. This is because the electric double layer that is formed at the surface of the sensor element in such a high salt concentration solution is thin, and because Debye shielding makes it difficult to detect the change of an electrical characteristic due to an event at the surface vicinity of the sensor element (e.g., the association between the target molecule and the probe molecule bound or adsorbed to the surface of the sensor element, modification of the probe molecule due to association with the target molecule, etc.).

According to the embodiment, based on the experiments described below, a favorable concentration range of the chlorine ions in the buffer solution was discovered in which the electric double layer can be thicker while stabilizing the potential of the buffer solution of the chemical sensor.

The experiment results will now be described.

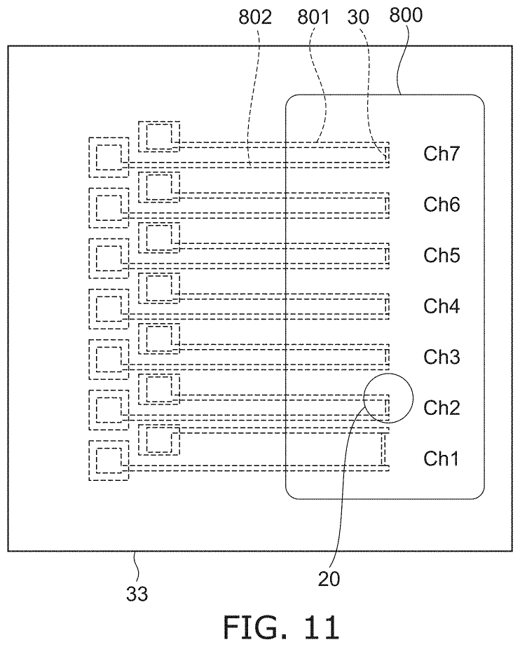

FIG. 11 is a schematic view of a sensor chip used in the experiments.

A measurement system of the seven channels Ch1 to Ch7 was provided on the substrate 33. Each of the channels Ch1 to Ch7 included the sensor element 30 that used a graphene film, and a pair of electrodes 801 and 802 that was electrically connected to the graphene film. One of the pair of electrodes 801 and 802 was the drain electrode; and the other was the source electrode. The surface of the sensor element 30 of each of the channels Ch1 to Ch7 was immersed in the buffer solution supplied to a well 800. The silver/silver chloride electrode 20 was immersed in the buffer solution inside the well 800 above the channel Ch2. A circular columnar silver/silver chloride electrode 20 extended into the page surface of FIG. 11 to face the channel Ch2.

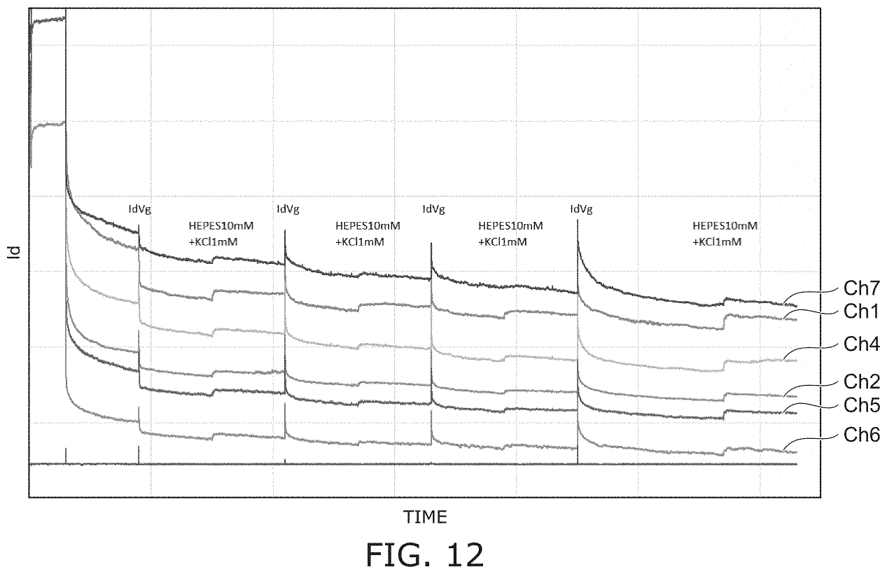

FIGS. 12 to 18 are graphs illustrating measurement results of the change over time (the horizontal axis) of a drain current Id (the vertical axis) flowing between the electrodes 801 and 802 via the graphene film. The gate voltage was constantly applied while measuring the change over time of the drain current. At the timing marked as IdVg in the figures, the change over time measurement was interrupted once, a gate sweep was performed, and the Id vs. Vg characteristic was acquired. Also, to eliminate the effects of drying, etc., for the measurement over a long period of time, the solution was refreshed with the same composition at the midpoint of the IdVg measurement.

FIG. 12 illustrates results using a buffer solution in which 1 mM of KCl (potassium chloride) was added to a 10 mM HEPES buffer solution. In the measurement, the potential Vg of the silver/silver chloride electrode 20 was 500 mV.

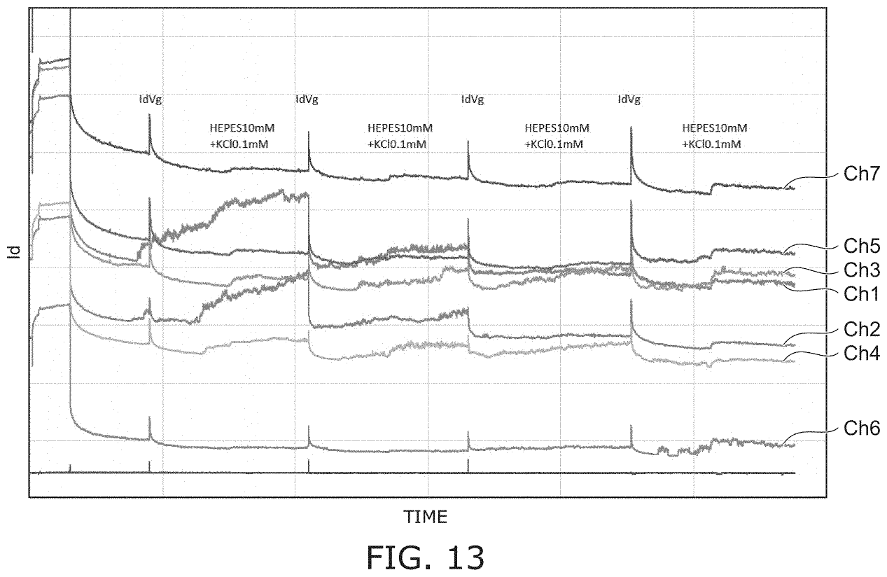

FIG. 13 illustrates results using a buffer solution in which 0.1 mM of KCl was added to a 10 mM HEPES buffer solution. In the measurement, the potential Vg of the silver/silver chloride electrode 20 was 500 mV.

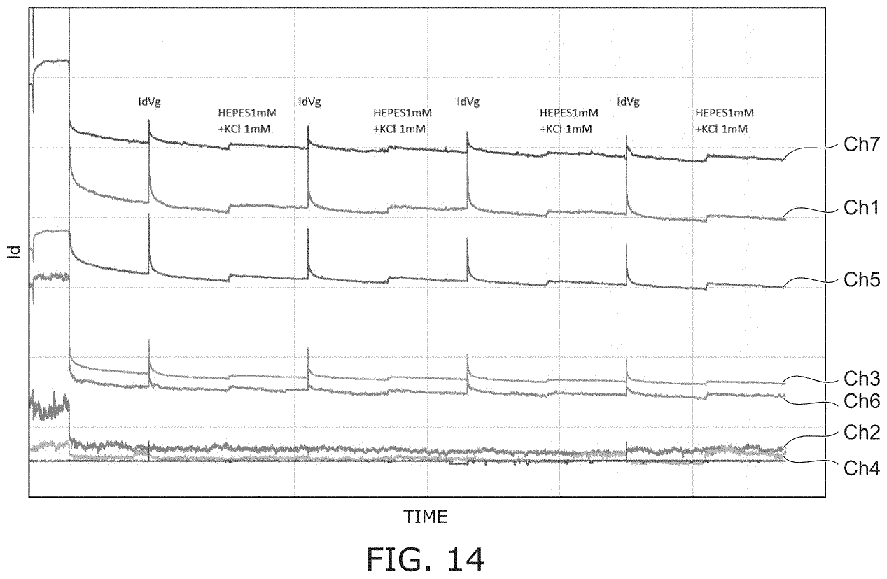

FIG. 14 illustrates results using a buffer solution in which 1 mM of KCl was added to a 1 mM HEPES buffer solution. In the measurement, the potential Vg of the silver/silver chloride electrode 20 was 460 mV.

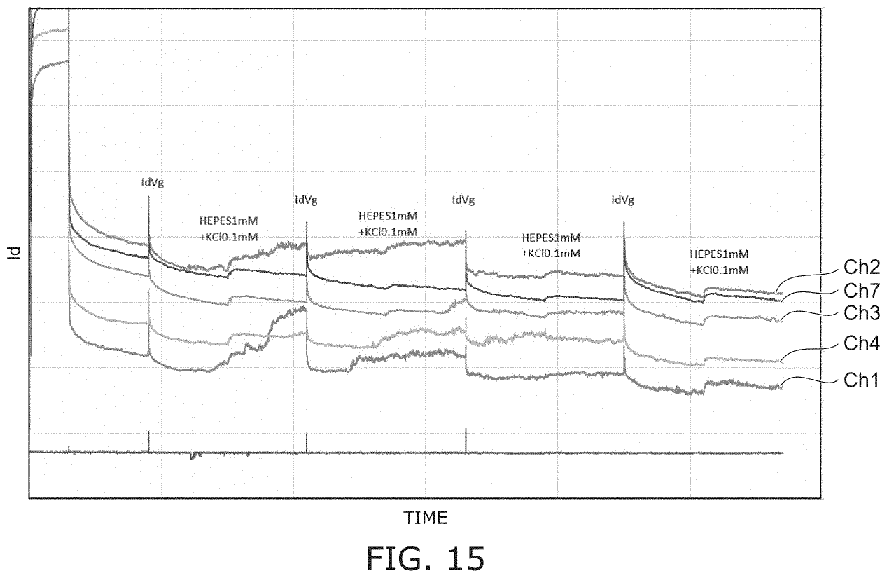

FIG. 15 illustrates results using a buffer solution in which 0.1 mM of KCl was added to a 1 mM HEPES buffer solution. In the measurement, the potential Vg of the silver/silver chloride electrode 20 was 500 mV.

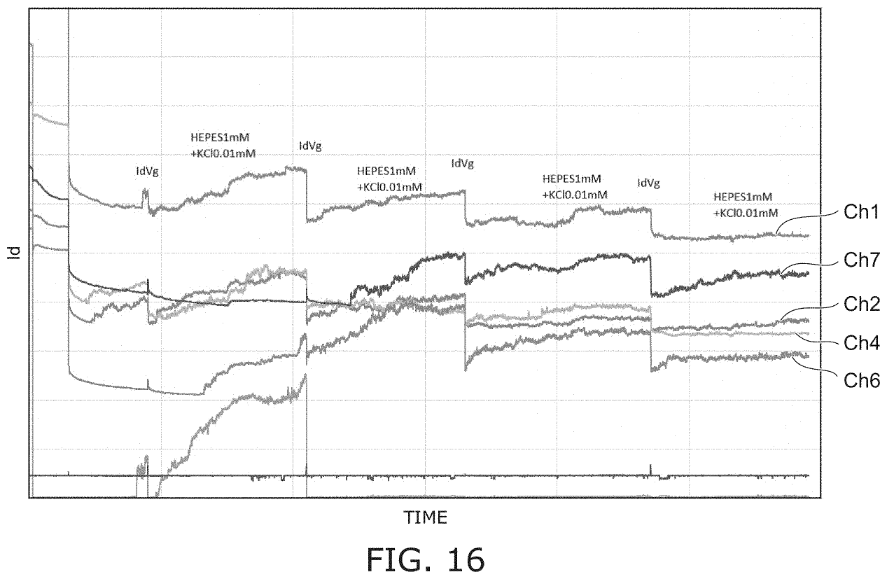

FIG. 16 illustrates results using a buffer solution in which 0.01 mM of KCl was added to a 1 mM HEPES buffer solution. In the measurement, the potential Vg of the silver/silver chloride electrode 20 was 500 mV.

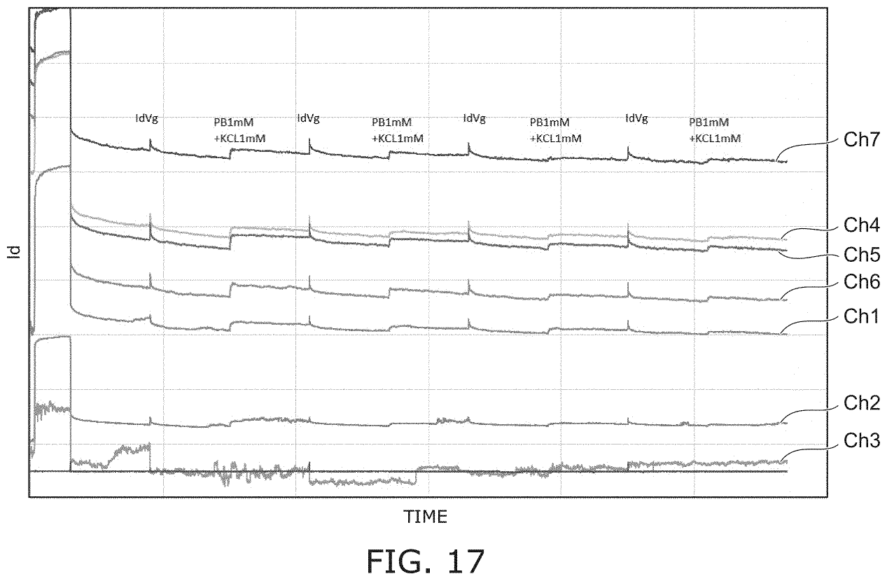

FIG. 17 illustrates results using a buffer solution in which 1 mM of KCl was added to a 1 mM phosphoric acid buffer solution. In the measurement, the potential Vg of the silver/silver chloride electrode 20 was 390 mV.

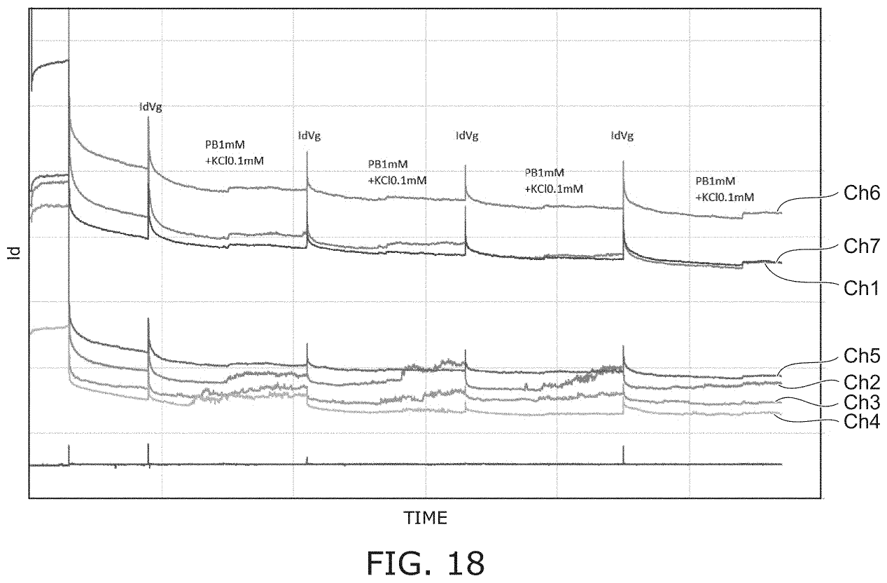

FIG. 18 illustrates results using a buffer solution in which 0.1 mM of KCl was added to a 1 mM phosphoric acid buffer solution. In the measurement, the potential Vg of the silver/silver chloride electrode 20 was 500 mV.

In FIGS. 12 to 18 described above, the potential Vg of the silver/silver chloride electrode 20 was set to a condition so that the gate voltage dependence of the drain current was large when pre-acquiring the gate voltage dependence. Specifically, the voltage that was used was 200 mV less than the charge neutral point when the drain current switched from hole conduction to electron conduction. However, the maximum setting value of the gate voltage was constrained to 700 mV to avoid electrolysis of the solution; therefore, when the charge neutral point was greater than 700 mV, the gate voltage was set to 700−200=500 mV. The gate voltage dependence of the drain current has a negative relationship for hole conduction and a positive relationship for electron conduction; therefore, the drain current is V-shaped with respect to the gate voltage; and the bottom of the V shape (not illustrated) can be read as the charge neutral point. The gate voltage of the experiments described below also are set using a similar procedure unless otherwise noted.

As shown in FIG. 13, FIG. 15, FIG. 16, and FIG. 18, Id was unstable when the chlorine ion concentration was 0.1 mM and 0.01 mM. It is considered that this is because the buffer solution potential undesirably fluctuated and a drift current was generated in the sensor element due to the increase or reduction of Cl⁻ generated proximate to the silver/silver chloride electrode in the dilute chlorine ion concentration.

As shown in FIG. 12, FIG. 14, and FIG. 17, compared to when the chlorine ion concentration was 0.1 mM and 0.01 mM, Id was stabilized for a chlorine ion concentration of 1 mM. Accordingly, it is favorable for the buffer solution to include not less than 1 mM of chlorine ions to stabilize the potential of the buffer solution and suppress the Id drift.

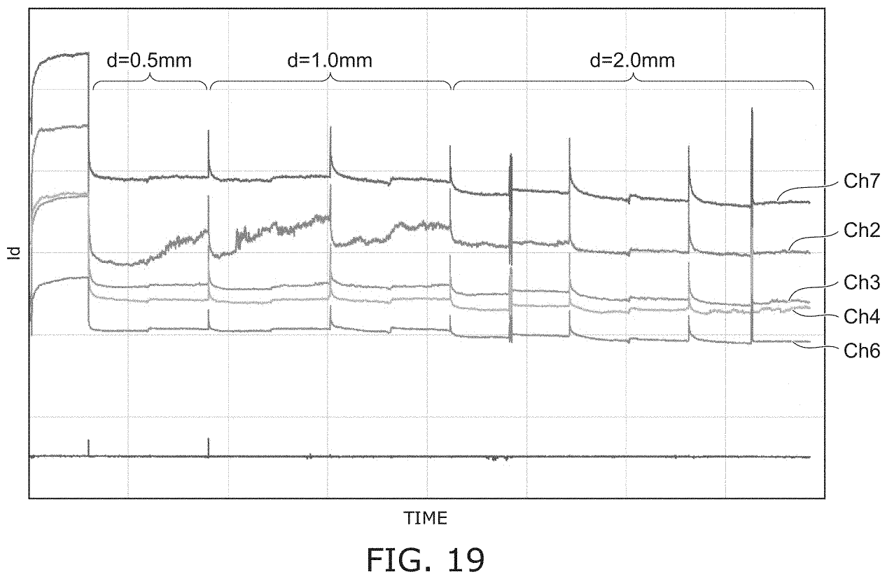

FIG. 19 is a graph illustrating results of measuring the temporal change of Id while changing the distance d between the silver/silver chloride electrode and the surface of the sensor element. In the sensor chip shown in FIG. 11, the distance d corresponds to the height of the lower surface of the silver/silver chloride electrode 20 from the surface of the sensor element 30. In the measurement, a buffer solution was used in which 0.5 mM of KCl was added to a 1 mM HEPES buffer solution. The potential Vg of the silver/silver chloride electrode 20 was 450 mV.

The results of FIG. 19 confirm that by controlling the distance between the silver/silver chloride electrode and the sensor element, the Id drift can be suppressed even when using a buffer solution that includes 0.5 mM of chlorine ions. To stabilize Id, it is favorable for the distance d between the silver/silver chloride electrode and the surface of the sensor element to be not less than 1 mm, and more favorably not less than 2 mm.

In the configuration of FIG. 7, the distance d between the silver/silver chloride electrode 20 and the surface 30a of the sensor element 30 is the distance in a plane parallel to the surface of the substrate 33. In the configuration of FIG. 10B, the distance d between the silver/silver chloride electrode 20 and the surface 30a of the sensor element 30 is the distance between the surface of the sensor element 30 exposed in the first opening 501 of the pipe and the silver/silver chloride electrode 20 exposed in the second opening 502 of the pipe.

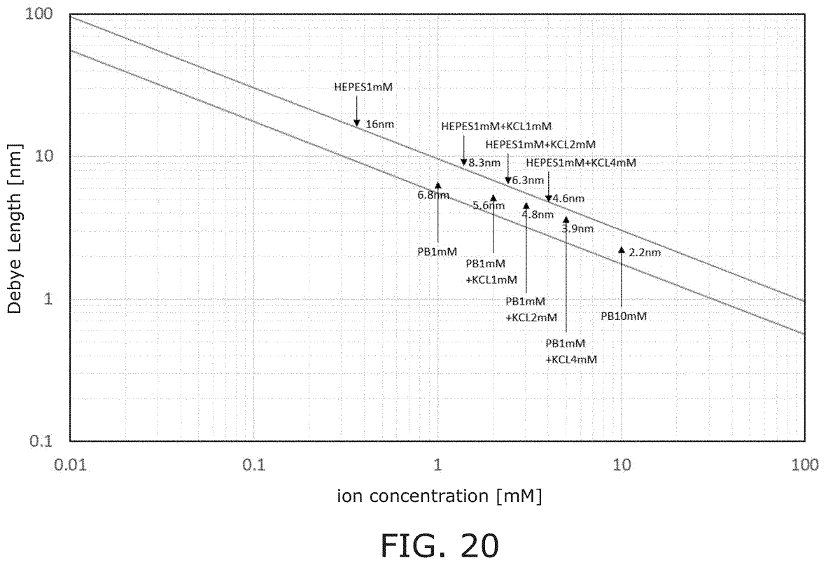

FIG. 20 is a graph showing a relationship between the ion concentration (the horizontal axis) and the Debye length (the vertical axis) in the buffer solution.

The Debye length was 16 nm when using a 1 mM HEPES buffer solution that did not include chlorine ions.

The Debye length was 8.3 nm when using a buffer solution in which 1 mM of KCl was added to a 1 mM HEPES buffer solution.

The Debye length was 6.3 nm when using a buffer solution in which 2 mM of KCl was added to a 1 mM HEPES buffer solution.

The Debye length was 4.6 nm when using a buffer solution in which 4 mM of KCl was added to a 1 mM HEPES buffer solution.

The Debye length was 6.8 nm when using a 1 mM phosphoric acid buffer solution that did not include chlorine ions.

The Debye length was 5.6 nm when using a buffer solution in which 1 mM of KCl was added to a 1 mM phosphoric acid buffer solution.

The Debye length was 4.8 nm when using a buffer solution in which 2 mM of KCl was added to a 1 mM phosphoric acid buffer solution.

The Debye length was 3.9 nm when using a buffer solution in which 4 mM of KCl was added to a 1 mM phosphoric acid buffer solution.

The Debye length was 2.2 nm when using a 10 mM phosphoric acid buffer solution that did not include chlorine ions.

For example, among probe molecules that originated in a living body and were provided at the surface of the sensor element, the probe molecule size for a nucleic acid aptamer was about 4 nm. Accordingly, if the Debye length is not less than 4 nm, the change of the electrical characteristics of the sensor element surface can be detected using the association of the probe molecule and the target molecule, a modification of the probe molecule due to association with the target molecule, etc., on the surface of the sensor element.

From the trend of the change of the Debye length due to the change of the ion concentration shown in FIG. 20, for a 1 mM phosphoric acid buffer solution, the Debye length is easily not less than 4 nm by including chlorine ions of not more than 4 mM, and more favorably not more than 2 mM; and for a 1 mM HEPES buffer solution, the Debye length is easily not less than 4 nm by including chlorine ions of not more than 6 mM, and more favorably not more than 4 mM.

Accordingly, from these experiment results, by using a buffer solution that includes not less than 0.5 nM and not more than 6 mM of chlorine ions, the electric double layer (the Debye length) can be thicker while stabilizing the potential of the buffer solution.

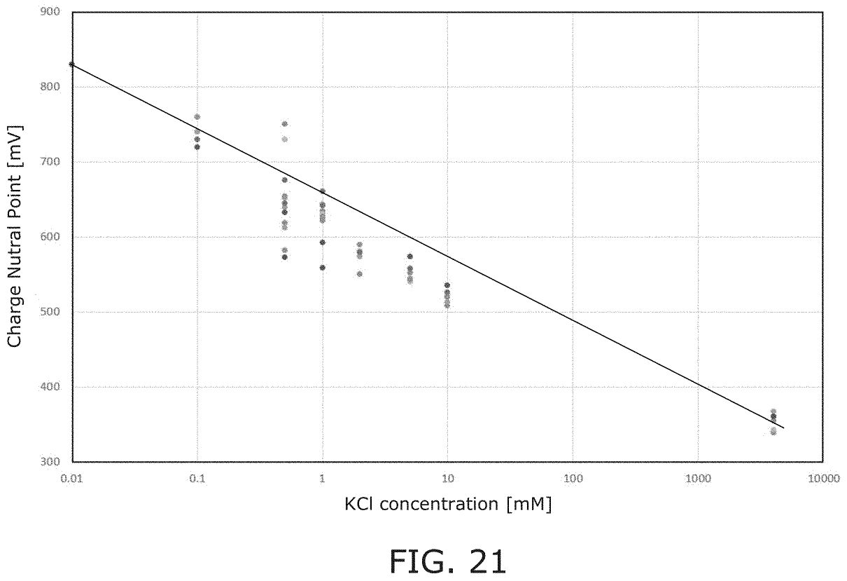

FIG. 21 is a graph showing a relationship between the charge neutral point of the graphene FET and the KCl concentration in the buffer solution (the horizontal axis).

It is favorable to measure the electrical characteristics of the graphene with a gate voltage that is not more than 700 mV because there is a risk that electrolysis of water may occur when applying a gate voltage greater than 700 mV, which may be accompanied by bubbles, erroneous detection, damage, etc. Here, when the charge neutral point is not less than 700 mV, the electrical characteristics of the graphene can be measured only in the electron conduction region at and below the charge neutral point; therefore, even if the change of the drain current is detected, it cannot be discriminated whether the change is due to the injection of a charge indicating the detection of the target, or a resistance fluctuation due to unintended physical damage. From the trend of the change of the charge neutral point due to the change of the KCl concentration shown in FIG. 21, if the KCl concentration is not less than 0.5 mM, the charge neutral point can be measured in a range (not more than 700 mV) in which electrolysis of water does not occur. Therefore, it is favorable for the chlorine ion concentration in the buffer solution to be not less than 0.5 mM.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A chemical sensor apparatus, comprising:
a buffer solution including not less than 0.5 mM and not more than 6 mM of chlorine ions;
a sensor element including a surface immersed in the buffer solution; and
a silver/silver chloride electrode immersed in the buffer solution,
the silver/silver chloride electrode applying a potential to the buffer solution, and including silver chloride at a surface of the silver/silver chloride electrode.

2. The apparatus according to claim 1, wherein
the buffer solution includes a phosphoric acid buffer solution or a HEPES (hydroxyethylpiperazine ethanesulfonic acid) buffer solution.

3. The apparatus according to claim 1, wherein
a distance between the silver/silver chloride electrode and the surface of the sensor element is not less than 1 mm.

4. The apparatus according to claim 1, further comprising:
a substrate on which the sensor element and the silver/silver chloride electrode are mounted; and
a pipe having an opening that exposes the surface of the sensor element and the silver/silver chloride electrode to an interior of the pipe,
the buffer solution flowing in the interior of the pipe.

5. The apparatus according to claim 4, wherein
the substrate can be attached to and detached from the opening.

6. The apparatus according to claim 1, further comprising:
a pipe in which the buffer solution flows,
the pipe including
a first opening exposing the surface of the sensor element to an interior of the pipe, and
a second opening exposing the silver/silver chloride electrode to the interior of the pipe.

7. The apparatus according to claim 1, wherein
the sensor element is a FET (Field Effect Transistor) element that includes graphene.
